(19) United States
(12) Patent Application Publication
(10) Pub. No.: US 2018/0283701 A1
(43) Pub. Date: Oct. 4, 2018

(54) Heating tile with raised channels

(71) Applicant: Bruce Blaine Williams, Gillette, WY (US)

(72) Inventor: Bruce Blaine Williams, Gillette, WY (US)

(21) Appl. No.: 15/530,991

(22) Filed: Apr. 4, 2017

(51) Int. Cl. F24D 13/02; H05B 3/26

(52) U.S. Cl. CPC F24D 13/024; H05B 2203/026; H05B 3/26

(57) ABSTRACT

A heating tile designed to be easily built without intervention by the tile manufacturer and installed using standard construction methods and materials while providing a radiant heating method that is compatible with both computer controlled systems as well as simple thermostat controls, can be repaired without major floor rework, does not produce a significant magnetic field, is protected against overheating due to excessive exposed surface insulation, and is water and contaminant resistant even if there is minor cracking of the tile.

### REFERENCES CITED

### U.S. Patent Documents

| | | | |
|---|---|---|---|
| 1,015,991 | Electric Heating pad | January 1912 | Clark |
| 2,004,857 | Apparatus for the distribution of heat | June 1935 | Deriaz |
| 2,533,409 | Electrical heating System************ | December 1950 | Tice |
| 2,559,077 | Resistive heating elements | July 1951 | Johnson et al. |
| 2,782,289 | Heating device [Wire resister heater] | February 1957 | Nathanson |
| 3,015,016 | Electrical heating units and the like [floor] | December 1961 | Cole |
| 3,153,140 | Radiant heating panel | October 1964 | Theodore et al. |
| 3,255,337 | Electrical heating pads for floors | June 1966 | Willat |
| 3,277,419 | Laminated heating unit | October 1966 | Butz |
| 4,327,282 | Electrical resistance heating element | April 1982 | Nauerth |
| 4,370,548 | Electrical heating element | January 1983 | Nagasawa et al. |
| 4,401,885 | Planar heat generating device | August 1983 | Ishii et al. |
| 4,426,573 | PTC Heating element | January 1984 | Fudickar et al. |
| 4,439,666 | Electrical heating system | March 1984 | Graham |
| 4,581,522 | Electrical heating system including a mesh | April 1986 | Graham |
| | heating element | | |
| 7,193,179 | Channeled under floor heating element | March 2007 | Horvath, et al. |
| 7,193,191 | Under floor heating element | March 2007 | Horvath, et al. |
| 8,306,408 | Radiant heating using heater coatings | November 2012 | Abbott |
| 8,461,486 | Heating Tile And Heated Floor Using The | Jun. 11, 2013 | Feng et al. |
| | Same | | |
| 9,185,748 | Electrical panel heating device and method | November 2015 | Zimmerer, et al. |
| | and building materials for the protection | | |
| | thereof | | |

### FEDERALLY SPONSORED RESEARCH OR DEVELOPMENT

None

### PARTIES TO A JOINT RESEARCH AGREEMENT

None

### RELATED APPLICATIONS

Patent application Ser. No. 14/999,598

### PRIOR DISCLOSURES

None

### BACKGROUND

### 1. Technical Field

The present disclosure generally relates to heating tiles and heated floor and floor back splashes using the same.

### 2. Description of Related Art

Heating a house in the present art can be divided into three distinct methodologies. The first is forced air heat. In this method there is a central heat source which involves the transfer of heat to air that is then forced throughout the house using an air fan.

This method has several drawbacks, primarily in that it produces a flow of air in the various rooms which causes noise and the side effect that moving air cools items quicker than stationary air. Since it is not practical to heat the air sufficiently high to cancel the cooling effect, there is generally a false feeling of coolness as the warmed a it is first forced into the rooms. It also requires the use of duct work which is not readily accessible and, due to the amount of air that goes through it, tends to collect contaminants which when disturbed can be spread throughout the house.

Their second general failure is that unless specifically designed with a lot of expensive “duct heaters” or dampers to control volume of air flow, individual rooms cannot be adjusted for the comfort of the applicable situation, such as sleeping rooms and cooking rooms verses living rooms or dens.

And the third disadvantage is that it is subject to the total loss of heating on a single failure. Any failure in the single unit heat source causes a complete loss of heating to the entire heated area.

The advantage to this system is that external air can be selectively introduced into the air stream and help keep gasses such as CO2 or CO from accumulating in the house.

The second method consists of using convection heating. In convection heating air is heated up by a relatively small local device such as a steam radiator or electrical baseboard heater. This heating method has three disadvantages including—by heating the air and letting it rise, the highest part of the structure is heated first and the lowest last, resulting in ceilings and upper floors that are relatively hot while the lower floor(s) are comfortable. This can be overcome by the proper use of ceiling fans and automatic doors, but these items are just unrelated capital and running expenses that are not directly supplying heat.

The second problem is that the heater is generally located either right on a wall or right next to a wall and this causes the paint in those areas to suffer from heat damage/fading over the years and the collection of unsightly contaminant deposits due to the air passing over these specific areas. In addition these systems place limitations on where room furniture can be placed as they generally require a minimum distance to combustible material. Removing wall space that could be used for furniture placement and/or decorative purposes.

The third disadvantage to this method is the lack of outside air introduction due to there being no force air involved.

The major advantage to convection heat is that you can control the heat on a room or even side of a room basis, which makes for a more comfortable overall heat compared to forced air heat.

The third method most commonly used is radiant heat, of which this device applies. Radiant heat overcomes most of the disadvantages of the other two systems. It is room specific heat and therefor, like convection heat, can make the house more comfortable and if properly designed can produce localized heat within a room on a finer scale than even convection heat.

It inherently overcomes the rapid air flow of forced air heat without any requirement for extra apparatus to keep the heat in low areas like convection heat requires.

The present art in radiant heat has some major disadvantages though. One of the most popular methods of radiant heat is that of hot water circulation under a floor. This method has several disadvantages including requiring access below the floor to use or take the chance you will have to remove your entire floor if there is ever a need to repair any defects that develop, both being expensive.

This method also introduces the problem of a leak in the water piping. If this occurs there is a good chance more than just the piping will be damaged and water damage is an add on to the insurance of a house. Along with that is that a slow leak may not be detected and may allow an unhealthy amount of mold to build up in hidden areas.

The water heating method also suffers from the total loss of heating on a single failure problem since any failure in the single heat source causes a complete loss of heating to the entire heated area.

Another disadvantage to water heating and forced air heating is the inefficiency of the methodologies. Both require a heating device somewhere to heat up the air/water and since most systems only run 80% to 90% efficient you are spending an additional 5% to 10% just for the convenience of the single heating unit (the other ½ efficiency loss will likely go to heating one of the heated areas, such as the room the heating unit is in).

Another disadvantage to water or under floor forced air radiant heat is that the extra equipment will require maintenance and thus will be another expense not associated directly with producing heat.

My prior patent application Ser. No. 14/999,598 is for a Heating Tile with built in recessed channels, this application is for a Heating Tile with raised channels added to existing tiles which creates an advantage because the tile manufacturer no longer has to manufacture tiles with and without channels for different climatic areas, as well as allows stone cutters to limit or eliminate the amount of cutting necessary to prepare the unit for installation of the heating component. It also allows an independent company to manufacture tiles from different suppliers to meet their customers needs as.

### BRIEF SUMMARY OF THE INVENTION

This invention overcomes several of the deficiencies of other radiant floor heating methods. By adding surface channels to the underside of tiles or stones or their non flammable equivalents you can install the heating system using methods practiced and materials used since ancient times, and well understood and practiced throughout the world. This is a significant savings in installation costs due to the expense of extra training for installers, and the materials used in installation would be off the shelf and readily available.

In addition, it overcomes the purchase of centralized heating units used in water systems and underfloor heated air systems. It also overcomes the expense of either purchasing treated wood for floor joists to prevent dry rot, or the expense of heating ducts for under floor heated air systems.

It does not require the use of water, which means there is no additional insurance considerations or worry about mold buildup.

It can be connected to standard household wiring systems (according to local electrical codes) and controlled by systems varying from complex energy management systems to simple single room thermostats. The control scheme can be simple on/off to sophisticated variable power control and zone control even within a single room. And upgrades are simply a matter of upgrading the control system, the tiles will stay the same and can be wired during installation to accommodate any future plans.

The work and planning involved in installing the tiles will be little more than what is required for the same floor using just tiles, and the material cost will be equivalent to a high end convection system, and less than either under floor forced air or heated water systems.

Radiant heat also allows the homeowner to lower the thermostat setting to keep the same feeling of warmth. Since the heat produced is primarily of a radiating nature it will not heat the ceiling or upper rooms as much as forced air or convection heating, and like the hot water and under floor heated air systems, will use less power of the same degree of comfort.

The one item this invention does not address is the addition of external air to the building as can be accomplished with forced air systems.

### BRIEF DESCRIPTION OF THE DRAWINGS

Many aspects of the embodiment's can be better understood with reference to the following drawings. The components in the drawings are not necessarily drawn to scale, the emphasis instead being placed upon clearly illustrating the principles of the embodiment's. Moreover, in the drawings, like reference numerals designate corresponding parts throughout the several views.

FIG. 1 is a schematic view of one embodiment of a heated tiled floor. Although this embodiment shows squares, the invention applies to any shape or arrangement of tiles.

FIG. 2 is a schematic of a heating tile used in the heating floor in FIG. 1. The layout of one embodiment is shown. The exact placement of the components is dependent on the design of the tile but all components that are required are presented.

### DETAILED DESCRIPTION OF THE INVENTION

The disclosure is illustrated by way of example and not by way of limitation in the figures of the accompanying drawings in which like references indicate similar elements. It should be noted that references to “an” or “one” embodiment in this disclosure are not necessarily to the same embodiment, and such references mean at least one.

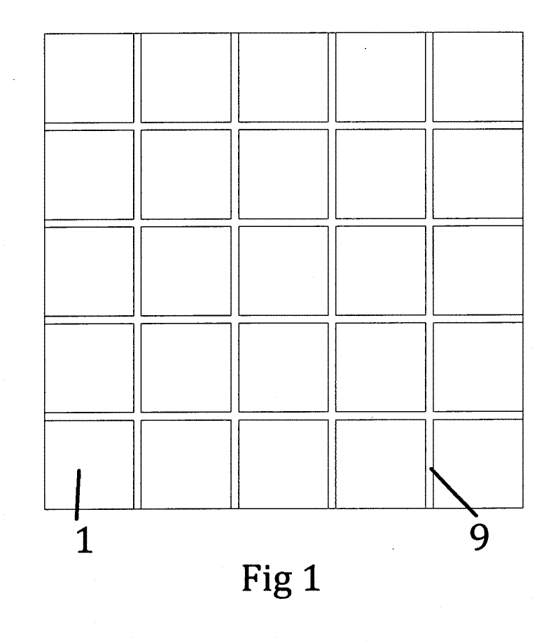

Referring to FIG. 1, a heating floor according to one embodiment is shown. The heating floor includes a plurality of heating tiles (1) disposed side by side and may be of any shape the design requires. The plurality of heating tiles (1) are arranged to form a plurality of lines and rows between which there may be a gap filled with some form of grout or equivalent (9) or the heating tiles (1) may be placed next to each other with no deliberate gap (9). The plurality of heating tiles (1) can be fixed with the floor using the standard tile securing material methods and materials.

The plurality of heating tiles can be electrically interconnected in any fashion as appropriate for the installation. They may be connected by number of tiles, or they may be grouped according to the designers plans, or the control system limitations, but in no case to exceed the current rating of the cold leads (6) of the tiles.

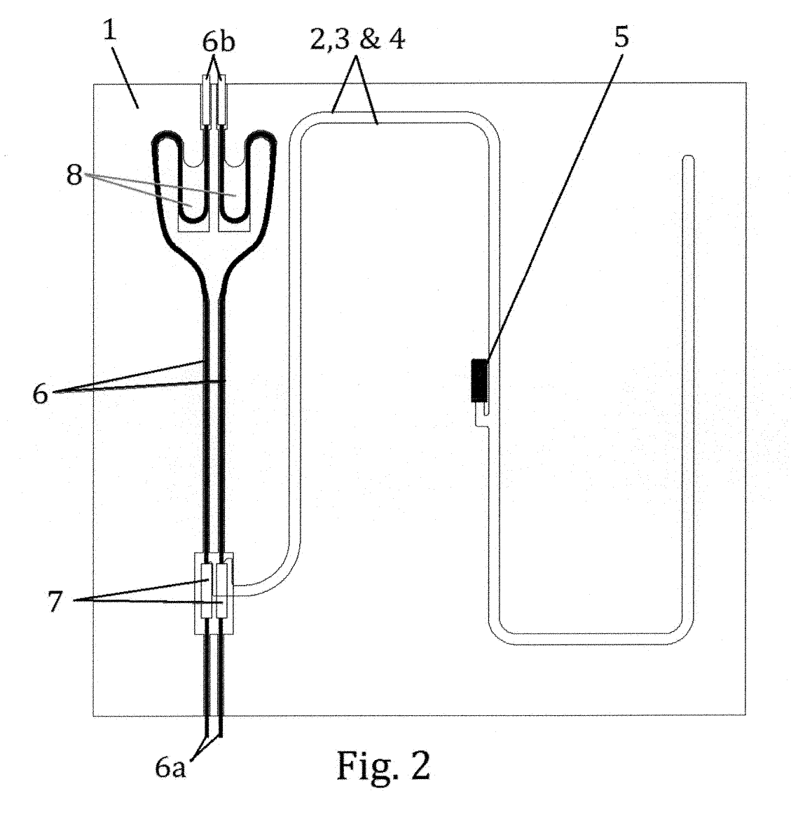

Referring to FIG. 2, each heating tile (1) includes raised enclosures (2) covering the heating elements (3) and the flexible covering (4) to allow minor cracking of the tile and shifting caused by normal floor deformations. In line with the heating element (3) there is an automatic reset over temperature cutout (5) to prevent the tile from getting to hot. This cutout would be activated by such things as storing large flat objects on the tile while the heat is on, or being covered by items placed on the floor such as pillows, blankets, throw rugs, etc.

The over temperature sensor may be located in different spots based on design criteria and tile shape and characteristics.

The cold leads (6,6a & 6b) are shown going straight through the tile, but can be designed to enter/leave any side, or even multiple sides if the design requires it. This allows the tiles to be designed so some may act as corner pieces or straight through pieces, or even multiple branch pieces as would best fit the application.

First end cold lead (6a) is the end which mates up to the second end (6b) cold lead and consists of enough bare electrically conductive material to make up with the connector on the second end (6b). The cold lead second end (6b) can be either a slip in connector or a mechanical connector using mechanical compression or soldering as the attachment method. The method used will depend on Electrical codes in the areas the tile is designed to be used in.

The slack take up chamber (8) will only be required when either types mechanical connections or solder sleeve connectors are used. This allows the connection to be made up and then any slack pushed back into the tile. On very thin tiles, this chamber may not be used and the leads may be countersunk into the flooring as determined by the installer. The exact size and shape of the take up chamber (8) will depend on the characteristics of the cold lead and the illustration is generic and not to scale.

Cold lead to heating element connection (7) is done at some point along the cold lead. The chamber may actually be the channel the cold leads (6) are running in or may accommodate both cold leads (6) within one chamber depending on the tile material and construction. It's exact placement will depend on the layout of the heating element (3) and were the most economical attachment point is.

Heating tile (1) provides a method of installation which requires minimum expertise outside of the normal expertise which would be required to install the tile without heat. It allows an installation in existing houses with little more effort than what would be required for a new floor overlay.

It is to be understood that the above-described embodiment's are intended to illustrate rather than limit the present disclosure. Variations may be made to the embodiment's without departing from the spirit of the disclosure as claimed. It is understood that any element of any one embodiment is considered to be disclosed to be incorporated with any other embodiment. The above-described embodiment's illustrate the scope of the disclosure but do not restrict the scope of the disclosure.

1. A heating tile comprising: an inflammable tile of rigid design with a melting point in excess of 200 C and an electrical conductivity value greater than or equal to 1×10⁶ Ωm.

2. The heating tile of claim 1, wherein raised channels have been added to the tile to hold the heating elements, over temperature sensor and cold leads. The raised channels being laid out such that the two cold leads, and separately the heating elements, run side by side and no more than 5 mm ( 13/64 in) between channels with the channels routed to have the currents in the side by side channels running in opposite directions. The close spacing helps cancel out any magnetic fields which may be generated.

3. A resistive heating element of the appropriate wattage within a flexible water resistant covering.

4. The heating tile of claim 2, wherein the resistive heating element of claim 3 is placed such that it has the ability to slide within the channels of claim 2. This allows the tile to crack under normal usage without exposing the resistive heating element of claim 3 to contact with liquids or the encroachment of fine contaminants.

5. A heating tile of claim 4, wherein a heat sensing element is wired in series with the heating element of claim 4 to shut current flow off if the temperature of the tile exceeds a preset value, generally 40° C. (104° F.) for a human occupancy, other applications may require higher or lower temperatures depending on their application.

6. The heating tile of claim 2, wherein two electrically insulated cold leads are placed in their appropriate channels and adhered loosely to the tile.

7. The heating tile of claim 6, wherein the electrically resistive heating elements of claim 4 are attached to the cold leads of claim 6.

8. The heating tile of claim 6, wherein the cold leads are terminated with those on one end being of exposed electrically conductive material. The other end being of either a hard and fast connector or a slide connector, both of which shall have a water seal against exposing the bare electrically conductive material to liquids after installation.
